(19) United States
(12) Patent Application Publication
(10) Pub. No.: US 2011/0114511 A1
(43) Pub. Date: May 19, 2011

(54) APPARATUS FOR DETECTING VOLATILE ORGANIC COMPOUNDS AND RELATED METHODS

(76) Inventor: Angele SJONG, Louisville, CO (US)

(21) Appl. No.: 12/619,909

(22) Filed: Nov. 17, 2009

(51) Int. Cl. G01N 27/26

(52) U.S. Cl. 205/777.5; 204/403.14

(57) ABSTRACT

Disclosed are apparatuses for detecting one or more volatile organic compounds (VOCs). The apparatuses include a primary electrode and a reference electrode. One or more particles are coupled to the primary electrode and the one or more particles are coupled to one or more enzymes that are capable of undergoing a redox reaction with at least one VOC. The apparatus is configured to measure current or voltage generated between the primary electrode and the reference electrode in response to the redox reaction. The apparatuses can detect a variety of VOCs, including VOCs associated with lung cancer. Also disclosed are biosensor systems including the apparatuses and methods of using the biosensor systems.

### BACKGROUND

The following description is provided to assist the understanding of the reader. None of the information provided or references cited is admitted to be prior art to the present invention.

Human breath contains a mixture of hundreds of volatile organic compounds (VOCs), which are generally exhaled in picomolar concentrations. See M. Philips et al., The Lancet, 353:1930-1933, Jun. 5, 1999; Machado et al., “Detection of Lung Cancer by Sensor Array Analyses of Exhaled Breath,” Am. J. Respir. Crit. Care Med., 171:1286-1291, 2005; and Mazzone, “Analysis of Volatile Organic Compounds in the Exhaled Breath for the Diagnosis of Lung Cancer,” Journal of Thoracic Oncology, 3(7):774-779, July 2008. Particular VOCs, combinations of VOCs, and/or concentrations of the VOCs may be associated with particular biological diseases or conditions. By way of example only, high concentrations of pentane in breath samples have been reported in breast cancer, acute myocardial infarction, heart transplant rejection, rheumatoid arthritis, and acute bronchial asthma. See M. Philips et al., The Lancet, 353:1930-1933, Jun. 5, 1999. Benzene has been associated with certain types of leukemia after chronic exposure in the workplace. See N. Rizvi et al., The Lancet, 353:1897-1898, Jun. 5, 1999. Concentrations of dimethylamine and ammonia can be elevated in the breath of subjects with liver impairment or uremia. See Mazzone, “Analysis of Volatile Organic Compounds in the Exhaled Breath for the Diagnosis of Lung Cancer,” Journal of Thoracic Oncology, 3(7):774-779, July 2008.

In another example, several VOCs have been shown to provide a “fingerprint” of lung cancer, a biological disease of particular concern. See M. Philips et al., The Lancet, 353:1930-1933, Jun. 5, 1999. Worldwide, over one million people die annually from lung cancer. Only sixteen percent of lung cancer cases are diagnosed at an early enough stage appropriate for surgical intervention and only nine percent are expected to survive past five years. Rising tobacco use in developing countries makes the worldwide incidence unlikely to change in the future. Early detection and treatment of lung cancer may increase the likelihood of surviving this disease.

Several methods have been employed to detect VOCs in the breath of subjects, including those having various stages of lung cancer. Among the methods are gas chromatography-mass spectrometry, carbon polymer sensor systems (also known as “electronic noses”), quartz microbalance sensor systems, colorimetric sensor arrays, mid-infrared laser systems, and canine scent detection. See M. Philips et al., The Lancet, 353:1930-1933, Jun. 5, 1999; M. McCulloch et al., Integrative Cancer Therapies, 5(1):1-10, 2006. Mazzone, “Analysis of Volatile Organic Compounds in the Exhaled Breath for the Diagnosis of Lung Cancer,” Journal of Thoracic Oncology, 3(7):774-779, July 2008; and Machado et al., “Detection of Lung Cancer by Sensor Array Analyses of Exhaled Breath,” Am. J. Respir. Crit. Care Med., 171:1286-1291, 2005. However, each of these methods suffers from drawbacks including high complexity, high expense, lack of portability, low practicality, and/or lack of sensitivity.

### SUMMARY

Provided herein are apparatuses for detecting volatile organic compounds (VOCs), biosensor systems including such apparatuses, and methods of using the biosensor systems. The disclosed apparatuses and biosensor systems incorporating such apparatuses are less expensive, less complex, more portable, and more sensitive than many of the conventional apparatuses used to detect VOCs.

In one aspect, the disclosure provides an apparatus for detecting one or more volatile organic compounds (VOCs) comprising: a primary electrode; one or more particles coupled to the primary electrode, wherein the one or more particles are coupled to one or more enzymes that are capable of undergoing a redox reaction with at least one VOC; and a reference electrode, wherein the apparatus is configured to measure current or voltage generated between the primary electrode and the reference electrode in response to the redox reaction.

In one embodiment, the reference electrode comprises one or more particles coupled to the reference electrode, wherein the one or more particles are coupled to one or more enzymes that do not undergo a redox reaction with a VOC. In one embodiment, the electrodes are each independently made of or coated by a material selected from gold, platinum, palladium, silver, carbon, copper, iridium, cobalt or indium tin oxide. In one embodiment, the one or more particles are metallic nanoparticles. In one embodiment, the metallic nanoparticles comprise gold, silver, platinum, iron, or combinations thereof. In an illustrative embodiment, the metallic nanoparticles are gold nanoparticles. In one embodiment, the one or more particles are coupled to the primary electrode via a linker molecule. In one embodiment, the linker molecule comprises one or more thiol groups.

In one embodiment, the one or more enzymes are selected from the group consisting of: an oxidase; a reductase; a hydrolase; and a hydroxylase. In one embodiment, the one or more enzymes are selected from the group consisting of: a cytochrome P450-dependent styrene monooxygenase, and an alkane hydroxylase. In one embodiment, the one or more enzymes are coupled to the one or more particles by an interaction selected from the group consisting of: an ionic bond, a covalent bond, and a metal chelate bond. In one embodiment, the one or more enzymes are modified to include one or more amino acids capable of forming an ionic bond, a covalent bond, or a metal chelate bond with the one or more particles.

In one embodiment, the at least one VOC is selected from the group consisting of: saturated hydrocarbons, unsaturated hydrocarbons, oxygen-containing VOCs, sulfur-containing VOCs, and nitrogen-containing VOCs. In one embodiment, the at least one VOC is selected from the group consisting of ethane, pentane, isoprene, acetone, ethyl mercaptane, dimethylsulfide, dimethylamine, and ammonia. In one embodiment, the at least one VOC is a VOC associated with lung cancer. In one embodiment, the at least one VOC is an unbranched or branched alkane or a cycloalkane having carbon numbers from C1 to C12. In one embodiment, the at least one VOC is selected from the group consisting of styrene; 2,2,4,6,6-pentamethyl-heptane; 2-methyl-heptane; decane; propyl-benzene; undecane; methyl-cyclopentane; 1-methyl-2-pentyl-cyclopropane; trichlorofluoro-methane; benzene; 1,2,4-trimethyl-benzene; 2-methyl-1,3-butadiene; 3-methyl-octane; 1-hexene; 3-methyl-nonane; 1-heptene; 1,4-dimethyl-benzene; 2,4-dimethyl-heptane; hexanal; 1-methylethenyl-benzene; hepatanal; isobutane; methanol; ethanol; acetone; pentane; isopropanol; dimethylsulfide; carbon disulfide; toluene; hexane; methyl pentane; o-toluidine; and aniline.

In an illustrative embodiment, the one or more particles are gold nanoparticles, the one or more enzymes are cytochrome P450-dependent styrene monooxygenase, and the at least one VOC is styrene. In an illustrative embodiment, the one or more particles are gold nanoparticles, the one or more enzymes are alkane hydroxylase, and the at least one VOC is decane.

In one embodiment, the apparatus further comprises one or more additional primary electrodes, wherein each additional primary electrode is coupled to one or more particles, the one or more particles coupled to one or more enzymes that are capable of undergoing a redox reaction with at least one VOC. In one embodiment, the one or more enzymes of the primary electrode and the one or more enzymes of each additional primary electrode are different.

In one aspect, the disclosure provides a biosensor system for detecting one or more volatile organic compounds (VOCs) comprising:

(a) a reaction cell comprising:
a primary electrode;
one or more particles coupled to the primary electrode, wherein the one or more particles are coupled to one or more enzymes that are capable of undergoing a redox reaction with at least one VOC; and
a reference electrode, and

(b) a detector configured to measure current or voltage generated between the primary electrode and the reference electrode in response to the redox reaction.

In one embodiment, the biosensor system is adapted to detect at least one VOC in the alveolar breath of a subject. In one embodiment, the biosensor system is adapted to detect at least one VOC from a sample of organic analytes that have been extracted from the alveolar breath of a subject using solid phase microextraction.

In one embodiment, the biosensor system further comprises a signal-displaying device to show the current or voltage generated between the primary electrode and the reference electrode.

In one aspect, the disclosure provides a method for detecting a volatile organic compound (VOC) in an assayed sample, the method comprising: (a) introducing the sample to be assayed into the reaction cell of the biosensor system, and (b) measuring the current or voltage generated between the primary electrode and the reference electrode.

In one embodiment, the methods further comprise comparing the measured current or voltage generated from the assayed sample to the measured current or voltage generated from a control sample, wherein the control sample does not comprise the VOC or comprises a known concentration of the VOC.

In one embodiment, the assayed sample is alveolar breath of a subject. In one embodiment, the assayed sample is a sample of organic analytes that have been extracted from the alveolar breath of a subject using solid phase microextraction. In one embodiment, the subject is a subject having lung cancer.

In one aspect, the disclosure provides a method for diagnosing lung cancer, the method comprising: (a) introducing alveolar breath from a test subject into the reaction cell of the biosensor system; (b) measuring the current or voltage generated between the primary electrode and the reference electrode; and (c) comparing the measured current or voltage generated from the alveolar breath of the test subject to the measured current or voltage generated from alveolar breath of a subject free of lung cancer, wherein a statistically significant difference in the measured currents or voltages indicates the presence of lung cancer.

In one aspect, the disclosure provides a method for diagnosing lung cancer, the method comprising: (a) introducing alveolar breath from a test subject into a solid phase microextraction device; (b) introducing the analytes captured in the solid phase microextraction device into the reaction cell of the biosensor system; (c) measuring the current or voltage generated between the primary electrode and the reference electrode; and (d) comparing the measured current or voltage generated from the alveolar breath of the test subject to the measured current or voltage generated from alveolar breath of a subject free of lung cancer, wherein a statistically significant difference in the measured currents or voltages indicates the presence of lung cancer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 depicts an illustrative embodiment of an apparatus for detecting a volatile organic compound (VOC).

FIG. 2 is a flow chart of an illustrative embodiment of a sample collection and assay procedure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Provided herein are apparatuses for detecting volatile organic compounds (VOCs), biosensor systems including such apparatuses, and methods of using the biosensor systems.

### Apparatuses

The disclosed apparatuses include a primary electrode and a reference electrode. The electrodes may be formed from, or coated with, a variety of materials, including, but not limited to, a conductive material such as a metal. Non-limiting examples of metals include gold, platinum, palladium, silver, copper, iridium, or cobalt. Other possible materials for the electrodes include carbon or indium tin oxide or metal compositions, such as gold-chitosan electrodes. The primary electrode and the reference electrode may be electrically coupled through a variety of means, including, but not limited to a wire. The primary electrode includes one or more particles coupled to the electrode and one or more enzymes coupled to the one or more particles. The enzymes include those that are capable of undergoing a redox reaction with a VOC. By “redox reaction” it is meant a reaction involving the transfer of electrons from the enzyme to the VOC in a reduction reaction or from the VOC to the enzyme in an oxidation reaction. The reference electrode may also include one or more particles coupled to the electrode and one or more enzymes coupled to the one or more particles. However, the enzymes coupled to the reference electrode may include those that do not undergo a redox reaction with a VOC. The disclosed apparatuses can be configured to measure current or voltage between the primary electrode and the reference electrode in response to a redox reaction between one or more enzymes coupled to the primary electrode and a VOC. By way of example only, the apparatuses can include a detector electrically coupled to the primary and reference electrodes such as a voltmeter for measuring voltage or an ammeter for measuring current. The apparatus can also include other standard components used in electrochemical cells.

In some embodiments, the apparatus further includes a mediator. As used herein “mediators” are compounds that mediate the transport of electrons between the enzyme active center and the electrode and also transfer electrons between the product of the enzymatic reaction and the electrode. By introducing a mediator, the operation potential (the potential at which the peak of the voltammetric curve is observed) may be reduced. A mediator also increases the quality of the signal resulting from the reaction and reduces the influences of factors that may interfere with the voltammetric signal. Examples of mediators applied to manufacture biosensors with selected enzymes are shown in Table 1.

TABLE 1
Examples of Mediators for Biosensors

| Enzyme | Mediator |
|---|---|
| Glucose oxidase | Ferrocenevinylferrocene |
| | hydroxymethylferrocene |
| | benzochinone |
| | TCNQ |
| | dimethylferrocene |
| Cholesterol oxidase | Hydroxymethylferrocene |
| | [Fe(CN)₆]⁴⁻ |
| Lactate oxidase | [Fe(CN)₆]⁴⁻ |
| Lactate dehydrogenase | ferrocenocarboxyl acid |
| Fructose dehydrogenase | Ferrocene |
| | hydroxymethylferrocene |
| | TCNQ |
| | Fe(CN) |
| Galactose oxidase | 1,1-dimethylferrocene |

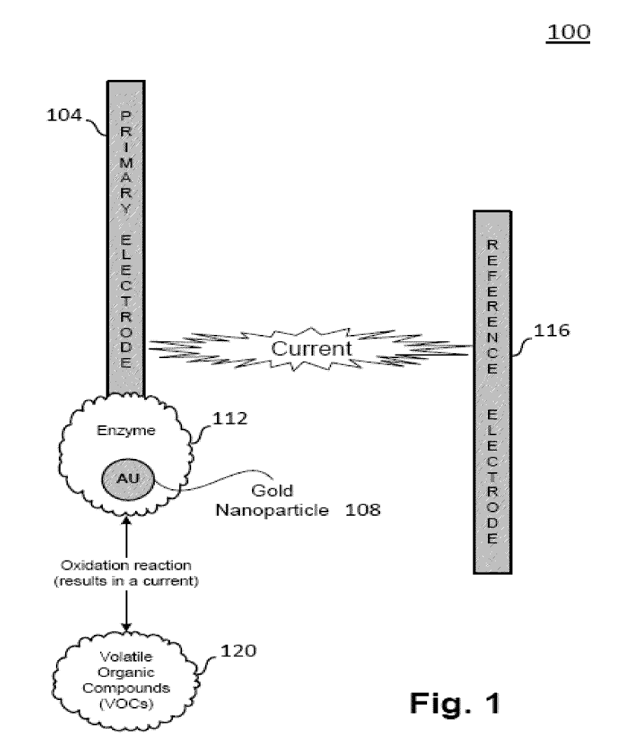

FIG. 1 depicts an illustrative embodiment of an apparatus for detecting a VOC. The term “detecting” is meant to encompass both determining the presence of the VOC and determining the concentration of the VOC. The apparatus 100 of FIG. 1 includes a primary electrode 104 coupled to a gold nanoparticle 108 and an enzyme 112 coupled to the gold nanoparticle. The apparatus 100 further includes a reference electrode 116. The apparatus 100 is configured to measure the current generated between the primary electrode 104 and the reference electrode 116 in response to a redox reaction of the enzyme 112 and one or more VOCs 120. When the VOCs 120 react with the enzyme, a current is generated and the gold nanoparticle (and the linker molecule coupling the nanoparticle to the electrode) provides an electrical pathway between the redox center of the enzyme and the electrode. The current can be quantitatively measured against the reference electrode 116. The generation of a current signal provides an indication of the presence of the VOC and the magnitude of the current signal provides an indication of the concentration of the VOC. Without wishing to be limited by theory, the use of metallic nanoparticles, which are efficient conductors, enhances the sensitivity of the apparatus. Moreover, the use of metallic nanoparticles eliminates the need for more complex chemical coupling schemes for immobilizing enzymes to electrodes, thus simplifying the apparatus and reducing the possibility of interference from other chemical reagents. Finally, the use of enzymes enhances the specificity of the apparatus since enzymes may be selected that are specific to only certain VOCs.

A variety of particles may be coupled to the primary electrode, the reference electrode, or both. By way of example only, the particles may be metallic nanoparticles. By “nanoparticle” it is meant a particle having a maximum dimension from about 0.5 nm to about 100 nm. This includes nanoparticles having a maximum dimension from about 0.5 nm to about 2 nm, from about 1 nm to about 50 nm, or from about 1 nm to about 10 nm. However, other ranges are possible. The shape of the nanoparticles may vary. Nanoparticles may be spherical in shape, but other shaped nanoparticles are possible, including, but not limited to nanorods, nanowires, and nanotubes. The metallic nanoparticles may be formed from a variety of metals including, but not limited to silver, gold, iron, platinum, and combinations thereof. Metallic nanoparticles are commercially available or may be made using known methods. In one embodiment, the metallic nanoparticles a hybrids of gold particles and chitosan. See J. Lin, H. Zhang, “New bienzymatic strategy for glucose determination by immobilized-gold nanoparticle-enhanced chemiluminescence,” Science in China, 52(2):196-202, 2009. In this illustrative embodiment, hybrids of gold nanoparticles and chitosan are chosen as the immobilization matrix of glucose oxidase to fabricate a biosensor.

The particles, including metallic nanoparticles, may be coupled to the primary electrode or the reference electrode by one or more linker molecules. A variety of linker molecules are possible, provided that the linker molecule is capable of conducting electrons and is capable of binding to the electrode at one end and the particle at the other end. By way of example only, linker molecules comprising thiol groups are capable of binding to metals such as gold, silver and platinum. In one embodiment, the linkers are attached to the electrode via a thiol-containing 3D network of silica gel (See Zhang, S. et al., “Immobilization of glucose oxidase on gold nanoparticles modified Au electrode for the construction of biosensor,” Sensors and Actuators, 109:367-74, 2005). Other linkers include, but are not limited to, regioregular poly-3-hexylthiophene (regP3HT) and dithiobisscuccinimidyl propionate (DTSP). See Pandey, P., “Polythiophene gold nanoparticles composite film for application to glucose sensor,” Journal of Applied Polymer Science, 110:988-994, 2008. In an illustrative embodiment, an enzyme can be immobilized onto gold nanoparticles that have been modified with a self-assembled monolayer of thioglycollic acid via covalent attachment by carbodiimide coupling reactions. Linker molecules are commercially available or may be made using known methods. Methods and conditions for reacting the linker molecules to the particles and electrodes are also known.

A variety of enzymes may be coupled to the disclosed particles. As described above, enzymes indirectly coupled to the primary electrode through one or more particles may include those that are capable of undergoing a redox reaction with a VOC. Such enzymes may include an oxidase, a reductase, a hydrolase, or a hydroxylase. A non-limiting example of an oxidase is cytochrome P450-dependent styrene monooxygensase, which is capable of oxidizing the VOC, styrene, as shown in Scheme I below. Degradation of styrene occurs by oxidation to phenylacetic acid, which is catalyzed by NADPH⁻ and flavin adenine dinucleotide-dependent styrene monooxygensase, followed by hydroxylation to homogentisic acid. Cytochrome P450-dependent styrene monooxygensase may be isolated from the yeast-like fungus Exophiala jeanselmei using known methods. See H. Cox et al., Appl. Environ. Microbiol., 62(4):1471-1474, April 1996.

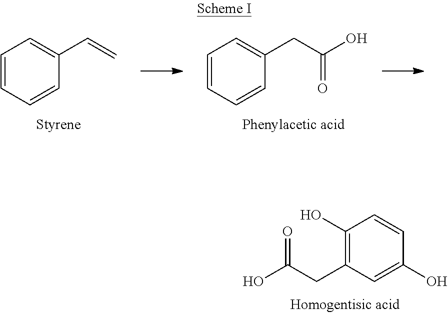

A non-limiting example of a hydroxylase is alkane hydroxylase, which is capable of oxidizing the VOC, decane. Alkane hydroxylase may be isolated from the CYP153 family of cytochrome P450 using known methods. See E. G. Funhoff et al., Enzyme and Microbial Technology, 40(4):806-812, March 2007.

As noted above, the enzymes are coupled to the electrodes through the disclosed particles. The enzymes may be coupled to the particles via a variety of interactions, including, but not limited to ionic bonds, covalent bonds, and metal chelate bonds. However, noncovalent bonding is also possible. It is possible to achieve any of these types of bonding interactions through the appropriate functional groups on the enzyme. Such functional groups may be naturally present on the enzyme or the enzyme may be modified via known methods to provide amino acids having functional groups capable of forming such bonds. By way of example only, an enzyme which naturally has a cysteine group is capable of forming covalent bonds to metals, alkenes, or to other thiol groups. Alternatively, thiolating reagents can be used to convert native amine groups from lysine into thiol groups. The particles disclosed above may be modified to provide the corresponding functional groups for reaction with the functional groups on the enzyme. As another non-limiting example, noncovalent bonding of the enzyme to the particle may be achieved through the avidin-biotin interaction, by modifying the enzyme to include an avidin (or biotin) and modifying the particle to include the corresponding biotin (or avidin).

In some embodiments, the apparatus may further include one or more membrane layers. In an illustrative embodiment, an enzyme specific for the substrate of interest may immobilized between two membrane layers, such as polycarbonate and cellulose acetate. The substrate is oxidized as it enters the enzyme layer, producing hydrogen peroxide, which passes through cellulose acetate to an electrode where the hydrogen peroxide is oxidized. The resulting current is proportional to the concentration of the substrate.

A variety of VOCs may be detected by the disclosed apparatuses. By way of example only, VOCs of interest may include those that may be present in the alveolar breath of a human subject. Such VOCs may include saturated hydrocarbons, unsaturated hydrocarbons, oxygen-containing VOCs, sulfur-containing VOCs, and nitrogen-containing VOCs. Non-limiting examples of saturated hydrocarbons include ethane and pentane. A non-limiting example of an unsaturated hydrocarbon includes isoprene. A non-limiting example of an oxygen-containing VOC includes acetone. Non-limiting examples of sulfur-containing VOCs include ethyl mercaptane and dimethylsulfide. Non-limiting examples of nitrogen-containing VOCs include dimethylamine and ammonia.

As another example, VOCs of interest include those that may be present in the alveolar breath of a subject having lung cancer, i.e., VOCs that are known to be associated with lung cancer. Such VOCs may include alkane molecules, including branched or unbranched alkanes and cycloalkanes having carbon numbers from C₁ to C₁₂. Specific examples of VOCs associated with lung cancer include the following molecules: styrene; 2,2,4,6,6-pentamethyl-heptane; 2-methyl-heptane; decane; propyl-benzene; undecane; methyl-cyclopentane; 1-methyl-2-pentyl-cyclopropane; trichlorofluoro-methane; benzene; 1,2,4-trimethyl-benzene; 2-methyl-1,3-butadiene; 3-methyl-octane; 1-hexene; 3-methyl-nonane; 1-heptene; 1,4-dimethyl-benzene; 2,4-dimethyl-heptane; hexanal; 1-methylethenyl-benzene; hepatanal; isobutane; methanol; ethanol; acetone; pentane; isopropanol; dimethylsulfide; carbon disulfide; toluene; hexane; methyl pentane; o-toluidine; isoprene 2-methylpentane, ethylbenzene, xylenes, octane pentamethylheptane and aniline. Each of these VOCs is known to be associated with lung cancer, including the early stages of lung cancer.

The apparatuses described above refer to a single primary electrode. However, it is to be understood that the apparatuses may include one or more additional primary electrodes. The additional primary electrodes include one or more particles coupled to the electrodes and one or more enzymes coupled to the particles. Any of the primary electrode materials, particles, and enzymes disclosed above may be used for these additional primary electrodes. In some embodiments, each primary electrode in an apparatus including multiple primary electrodes includes a different enzyme capable of undergoing a redox reaction with a VOC. Such apparatuses may be used to detect multiple VOCs in a mixture of VOCs, each primary electrode sensitive to a different VOC.

### Biosensor Systems

Any of the apparatuses disclosed above can be incorporated into a biosensor system. The biosensor systems include a reaction cell including any of the apparatuses disclosed above and a detector. The detector is configured to measure current or voltage generated between the primary electrode and the reference electrode in response to a redox reaction of the one or more enzymes on the primary electrode and at least one VOC. The reaction cell may include a housing adapted to encompass the various components of the apparatus and to contain the sample including the VOCs. The shape, size, and materials used for the reaction cell are not critical provided they are compatible with the components of the apparatus and the VOCs. A variety of detectors may be used, including the voltmeters and ammeters described above. The biosensor systems may be further adapted to detect VOCs in the alveolar breath of a subject. By way of example only, such biosensor systems may include an inlet for introducing the alveolar breath to the reaction cell and an outlet for removing the alveolar breath from the reaction cell after analysis. The inlet may further include a mouthpiece through which a subject may introduce the alveolar breath.

In another illustrative embodiment, biosensor systems may include an inlet for receiving a liquid sample. For instance, the exhaled breath may be sampled using a solid phase microextraction (SPME) device (described below). The organic analytes present in the breath of a subject are captured by the device and subsequently extracted into an appropriate solvent. The solvent containing the organic analytes may be assayed using the biosensor system.

Other components may be included in the biosensor systems such as those used in known “breathalyzer” systems. The biosensor systems may further include a signal-displaying device to show the current or voltage generated between the primary electrode and the reference electrode. A variety of signal-displaying devices may be used including, but not limited to LCD displays.

### Methods

The disclosed apparatuses and biosensor systems may be used in a variety of applications. One application involves a method for detecting a VOC in an assayed sample. The method includes introducing a sample to be assayed into the reaction cell of any of the disclosed biosensor systems and measuring the current or voltage generated between the primary electrode and the reference electrode of the biosensor system. The generation of a current or voltage provides an indication that a VOC specific to the enzyme coupled to the primary electrode of the biosensor system is present in the assayed sample. In addition, the magnitude of the current or voltage provides an indication of the concentration of the VOC in the assayed sample. The method can further include comparing the measured current or voltage generated from the assayed sample to the measured current or voltage generated from a control sample. The control sample can be a sample that does not include the VOC of interest or that includes a known concentration of the VOC. In other embodiments, a standard curve may be generated by measuring the electrical current or voltage generated from samples of known concentrations of VOCs. The voltage or current generated in test samples may then be compared to the standard curve.

In one embodiment, the apparatus is used to sample exhaled breath. Because the concentrations of VOCs in lungs may be relatively low, i.e., in parts per billion (ppb) to parts per trillion (ppt) levels (10⁻⁹ to 10⁻¹²), the sample may be concentrated using various means. In one embodiment, the subject breathes through a plastic tube connected to a sterilized valve and a sampling bag with absorbent cartridges to collect VOCs for later analysis. The system is designed to isolate the subject from environmental contaminants using a clamp attached to the person's nose, and the patients inhale purified air from a reservoir. The subject may breathe into the sampling device for at least 2 minutes, at least 5 minutes, at least 10 minutes or at least 15 minutes. The longer that a subject breathes into the device, the more VOCs will be collected. Assuming an average of 12 breaths per minute with 0.5 L of air exhaled per breath, a 4 minute sampling period will collect VOCs from approximately 24 L of exhaled air.

Several methods may be used to concentrate the VOCs from a patient sample once the sample has been collected. These methods include, but are not limited to, adsorptive binding, cold trapping, and supercritical fluid extraction. In an illustrative embodiment, the exhaled breath may be sampled using solid phase microextraction (SPME). SPME is an extraction technique in which a fused coated silica fiber is used as the stationary phase. The fiber coating removes the compounds from the sample by absorption. This method may be used to concentrate breath samples before analysis, with a minimum sensitivity of at least 10⁻² ng/ml, which is sensitive enough to analyze alkanes and aromatic hydrocarbons in the human breath at concentrations ranging from parts per trillion (ppt) to parts per billion (ppb). SPME has two steps: solute absorption from the sample matrix into an adsorptive material and transfer of the analytes into an analysis system by gaseous or liquid means. SPME relies upon the extraction of solutes from a sample into the SPME absorptive layer. After a sampling period, the absorbed solutes are transferred with the SPME layer into an inlet system that desorbs the solutes into a liquid phase. The liquid phase is then assayed using the biosensors described herein.

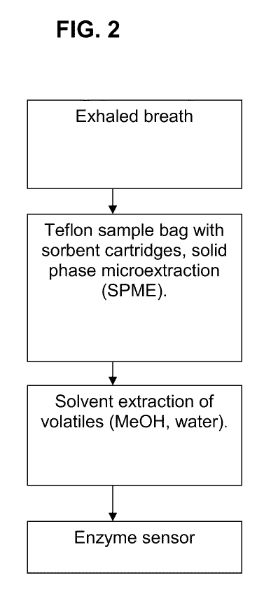

An illustrative embodiment of the sampling protocol and extraction with SPME is shown in FIG. 2. A sample of extracted breath is taken using a SPME device. The organic analytes that have become absorbed to the device would then be extracted with solvent, e.g., water, methanol, or water/methanol combinations. The solvent would then be read using the apparatus described herein to detect specific analytes.

The methods can further include associating the presence of one or more VOCs and/or particular concentrations of the VOCs with a biological disease or condition. As discussed above, particular VOCs, combinations of VOCs, and/or concentrations of the VOCx may be associated with particular biological diseases or conditions. Thus, detection of such VOCs can indicate the presence of the biological disease or concern.

A variety of samples may be analyzed by the disclosed methods, including the alveolar breath of a subject. By “subject,” it is meant any animal, including mammals, e.g., a human, a primate, a dog, a cat, a horse, a cow, a pig, or a rodent, e.g., a rat or mouse. The subjects may be normal, healthy subjects or subjects having, or at risk for developing, a particular biological disease or condition. By way of example only, the subject may be a subject having, or at risk for developing, lung cancer.

Another application involves a method for diagnosing lung cancer in a subject. The method is based on the fact that particular VOCs, combinations of VOCs and/or concentrations of the VOCs are associated with lung cancer as described above. The method includes introducing alveolar breath from a test subject into the reaction cell of any of the disclosed biosensor systems; measuring the current or voltage generated between the primary electrode and the reference electrode of the biosensor system; and comparing the measured current or voltage generated from the alveolar breath of the test subject to the measured current or voltage generated from the alveolar breath of a subject free of lung cancer. The presence of certain VOCs and/or the concentration of certain VOCs in the alveolar breath of the test subject as compared to that of the subject free of lung cancer can indicate the presence of lung cancer. In particular, a statistically significant difference in the measured currents or voltages of the alveolar breath of the test subject and the alveolar breath of the subject free of lung cancer can indicate the presence of lung cancer.

### EXAMPLES

The present disclosure is further illustrated by the following examples, which should not be construed as limiting in any way.

### Example 1

### Preparation of a Styrene Biosensor

N6-(2-aminoethyl)-flavin adenine dinucleotide is synthesized and purified as described in A. F. Bückmann, V. Wray, A. Stocker, in Methods in Enzymology: Vitamins and Coenzymes, D. B. McCormick Ed., Academic Press, Orlando, 1997, Vol. 280, part J, pp. 360-374. Cytochrome P450-dependent styrene monooxygenase from the fungus Exophiala jeanselmei is prepared in an E. coli recombinant system. 4,4′-Biphenyldithiol is synthesized as described in R. G. Bass, E. Cooper, P. M. Hergenrother, J. W. Connell, J. Polym. Sci. 25, 2395, 1987. Sulfo-N-hydroxy-succinimido-Au-nanoparticles are purchased from Nanoprobes (U.S.A.) and 1,4-benzenedithiol is purchased from TCI (Japan). All other chemicals are purchased from Aldrich or Sigma. Ultrapure water is used in all experiments.

Sulfo-N-hydroxy-succinimido-Au-nanoparticles, 6×10⁻⁵ M, are reacted with 6.8×10⁻⁴ M N6-(2-aminoethyl)-flavin adenine dinucleotide, in 0.03 M HEPES-buffer, pH 7.9, for 1 hour at room temperature and then overnight at 4° C. The functionalized Au-nanoparticle conjugate is purified from the excess of non-reacted N6-(2-aminoethyl)-flavin adenine dinucleotide using a spin-column device (Spin Column-30, Sigma). The resulting conjugate is characterized by absorbance spectroscopy and the ratio of N6-(2-aminoethyl)-flavin adenine dinucleotide and Au-nanoparticle in the nanoparticle hybrid is found to be 1:1.

The cytochrome P450-dependent styrene monooxygenase, 3 mg mL⁻¹ is reconstituted with the functionalized Au nanoparticle conjugate, 4.8×10⁻⁶ M, in 0.1 M phosphate buffer, pH 7.0, that includes 30% w/v glycerol, 0.1% w/v bovine serum albumin, 0.1% w/v sodium azide, for 4 hours at room temperature and then overnight at 4° C. The cytochrome P450-dependent styrene monooxygenase reconstituted with the functionalized Au-nanoparticle is purified using a centrifugal filter device (Centricon YM-100, Millipore).

Clean Au-wire electrodes (0.5 mm diameter, 0.2 cm² geometrical area, roughness factor ca. 1.3) are modified by the dithiols 4,4′-Biphenyldithiol, 1,4-benzenedithiol, or 1,4-dimercaptoxylene by the interaction with ethanolic solutions of the respective dithiol, 10 mM, for 2 hours, followed by rinsing of the electrodes with ethanol and water. The cytochrome P450-dependent styrene monooxygenase reconstituted with functionalized Au-nanoparticle conjugate, ca. 1×10⁻⁶ M, is adsorbed onto the dithiol-modified Au electrode by interacting the modified electrode and the reconstituted enzyme in a phosphate buffer overnight at 4° C. The second modification route of the electrode includes the adsorption of functionalized Au nanoparticle conjugate, 4.8×10⁻⁶ M, onto the dithiol-modified Au-electrode overnight at 4° C. and further reconstitution of cytochrome P450-dependent styrene monooxygenase, 3 mg mL⁻¹, on the functionalized interface overnight at 4° C. According to these procedures, it is predicted that the surface of the electrode will be approximately 60% covered with a monolayer of cytochrome P450-dependent styrene monooxygenase.

A three-compartment electrochemical cell is constructed, which includes the cytochrome P450-dependent styrene monooxygenase-modified Au electrode as a working electrode, a large area glassy carbon auxiliary electrode isolated by a glass frit, and a saturated calomel electrode (SCE) connected to the working volume with a Luggin capillary. This device is linked to a computer to record electrochemical potential. It is predicted that current measured by the oxidation at the electrode surface will increase as the concentration of styrene in the sample increases. It is predicted that a styrene concentration of less than 1 mM may be detected using the biosensor.

### Example 2

### Preparation of a Decane Biosensor

N6-(2-aminoethyl)-flavin adenine dinucleotide is synthesized and purified as described in A. F. Bückmann, V. Wray, A. Stocker, in Methods in Enzymology: Vitamins and Coenzymes, D. B. McCormick Ed., Academic Press, Orlando, 1997, Vol. 280, part J, pp. 360-374. Alkane hydroxylase from the CYP153 family of cyochrome P450 is prepared in an E. coli recombinant system. 4,4′-Biphenyldithiol is synthesized as described in R. G. Bass, E. Cooper, P. M. Hergenrother, J. W. Connell, J. Polym. Sci. 25, 2395, 1987. Sulfo-N-hydroxy-succinimido-Au-nanoparticles are purchased from Nanoprobes (U.S.A.) and 1,4-benzenedithiol is purchased from TCI (Japan). All other chemicals are purchased from Aldrich or Sigma. Ultrapure water is used in all experiments.

Sulfo-N-hydroxy-succinimido-Au-nanoparticles, 6×10⁻⁵ M, are reacted with 6.8×10⁻⁴ M N6-(2-aminoethyl)-flavin adenine dinucleotide, in 0.03 M HEPES-buffer, pH 7.9, for 1 hour at room temperature and then overnight at 4° C. The functionalized Au-nanoparticle conjugate is purified from the excess of non-reacted N6-(2-aminoethyl)-flavin adenine dinucleotide using a spin-column device (Spin Column-30, Sigma). The resulting conjugate is characterized by absorbance spectroscopy and the ratio of N6-(2-aminoethyl)-flavin adenine dinucleotide and Au-nanoparticle in the nanoparticle hybrid is found to be 1:1.

The alkane hydroxylase, 3 mg mL⁻¹ is reconstituted with the functionalized Au nanoparticle conjugate, 4.8×10⁻⁶ M, in 0.1 M phosphate buffer, pH 7.0, that includes 30% w/v glycerol, 0.1% w/v bovine serum albumin, 0.1% w/v sodium azide, for 4 hours at room temperature and then overnight at 4° C. The alkane hydroxylase reconstituted with the functionalized Au-nanoparticle is purified using a centrifugal filter device (Centricon YM-100, Millipore).

Clean Au-wire electrodes (0.5 mm diameter, 0.2 cm² geometrical area, roughness factor ca. 1.3) are modified by the dithiols 4,4′-Biphenyldithiol, 1,4-benzenedithiol, or 1,4-dimercaptoxylene by the interaction with ethanolic solutions of the respective dithiol, 10 mM, for 2 hours, followed by rinsing of the electrodes with ethanol and water. The alkane hydroxylase reconstituted with functionalized Au-nanoparticle conjugate, ca. 1×10⁻⁶ M, is adsorbed onto the dithiol-modified Au electrode by interacting the modified electrode and the reconstituted enzyme in a phosphate buffer overnight at 4° C. The second modification route of the electrode includes the adsorption of functionalized Au nanoparticle conjugate, 4.8×10⁻⁶ M, onto the dithiol-modified Au-electrode overnight at 4° C. and further reconstitution of alkane hydroxylase, 3 mg mL⁻¹, on the functionalized interface overnight at 4° C. According to these procedures, it is predicted that the surface of the electrode will be approximately 60% covered with a monolayer of alkane hydroxylase.

A three-compartment electrochemical cell is constructed, which includes the alkane hydroxylase modified Au electrode as a working electrode, a large area glassy carbon auxiliary electrode isolated by a glass frit, and a saturated calomel electrode (SCE) connected to the working volume with a Luggin capillary. This device is linked to a computer to record electrochemical potential. It is predicted that current measured by the oxidation at the electrode surface will increase as the concentration of decane in the sample increases. It is predicted that a decane concentration of less than 1 mM may be detected using the biosensor.

### Example 3

### Assays of Styrene and Decane in Exhaled Breath from Lung Cancer Patients

Biosensors for the detection of styrene and decane analytes are assembled as described in Examples 1 and 2. Samples of exhaled breath are obtained from human subjects with a confirmed histological diagnosis of lung cancer, as well as control human subjects with no known lung cancer. Sample collection involves collecting a breath sample directly onto a solid phase micro-extraction (SPME) fiber assembly. The SPME fiber is placed in proximity to the mouth of the subject and the sample collected for approximately four minutes. Based on an estimate of 12 breaths per minute with 0.5 L per breath, approximately 24 L of air will be sampled in a 4 minute period.

The absorbed solutes are transferred with the SPME layer into an inlet system that desorbs the solutes into a methanol/water solvent With SPME, one can extract with a very low volume of solvent (1 μL to 1 mL) or extract with a larger volume (1 mL or more) and concentrate to a small volume (1 μL). By concentrating a large number of breaths into a small sample volume, it is possible to detect VOCs that were at a parts per billion level in the lung to approximately 10⁻⁵ to 10⁻² M, which is within the limits of detection for the apparatus.

The liquid phase is then placed into the electrochemical cell of the biosensor and the current generated by the oxidation at the electrode surface is be measured. The amount of current can be correlated to the concentration of decane or styrene in the sample using a standard curve. It is predicted that subjects with lung cancer will have a higher concentration of styrene and decane in exhaled breath than control subjects.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 particles refers to groups having 1, 2, or 3 particles. Similarly, a group having 1-5 particles refers to groups having 1, 2, 3, 4, or 5 particles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein are incorporated by reference in their entireties and for all purposes to the same extent as if each individual publication, patent, or patent application was specifically and individually incorporated by reference in its entirety for all purposes.

What is claimed is:

1. An apparatus for detecting one or more volatile organic compounds (VOCs) comprising:
a primary electrode;
one or more particles coupled to the primary electrode, wherein the one or more particles are coupled to one or more enzymes that are capable of undergoing a redox reaction with at least one VOC; and
a reference electrode,
wherein the apparatus is configured to measure current or voltage generated between the primary electrode and the reference electrode in response to the redox reaction.

2. The apparatus of claim 1, wherein the reference electrode comprises one or more particles coupled to the reference electrode, wherein the one or more particles are coupled to one or more enzymes that do not undergo a redox reaction with a VOC.

3. The apparatus of claim 1, wherein the electrodes are each independently made of or coated by a material selected from gold, platinum, palladium, silver, carbon, copper, iridium, cobalt or indium tin oxide.

4. The apparatus of claim 1, wherein the one or more particles are metallic nanoparticles.

5. The apparatus of claim 4, wherein the metallic nanoparticles comprise gold, silver, platinum, iron, or combinations thereof.

6. The apparatus of claim 4, wherein the metallic nanoparticles are gold nanoparticles.

7. The apparatus of claim 1, wherein the one or more particles are coupled to the primary electrode via a linker molecule.

8. The apparatus of claim 7, wherein the linker molecule comprises one or more thiol groups.

9. The apparatus of claim 1, wherein the one or more enzymes are selected from the group consisting of: an oxidase; a reductase; a hydrolase; and a hydroxylase.

10. The apparatus of claim 1, wherein the one or more enzymes are selected from the group consisting of: a cytochrome P450-dependent styrene monooxygenase, and an alkane hydroxylase.

11. The apparatus of claim 1, wherein the one or more enzymes are coupled to the one or more particles by an interaction selected from the group consisting of: an ionic bond, a covalent bond, and a metal chelate bond.

12. The apparatus of claim 1, wherein the one or more enzymes are modified to include one or more amino acids capable of forming an ionic bond, a covalent bond, or a metal chelate bond with the one or more particles.

13. The apparatus of claim 1, wherein the at least one VOC is selected from the group consisting of: saturated hydrocarbons, unsaturated hydrocarbons, oxygen-containing VOCs, sulfur-containing VOCs, and nitrogen-containing VOCs.

14. The apparatus of claim 13, wherein the at least one VOC is selected from the group consisting of ethane, pentane, isoprene, acetone, ethyl mercaptane, dimethylsulfide, dimethylamine, and ammonia.

15. The apparatus of claim 1, wherein the at least one VOC is a VOC associated with lung cancer.

16. The apparatus of claim 15, wherein the at least one VOC is an unbranched or branched alkane or a cycloalkane having carbon numbers from C₁ to C₁₂.

17. The apparatus of claim 15, wherein the at least one VOC is selected from the group consisting of styrene; 2,2,4,6,6-pentamethyl-heptane; 2-methyl-heptane; decane; propyl-benzene; undecane; methyl-cyclopentane; 1-methyl-2-pentyl-cyclopropane; trichlorofluoro-methane; benzene; 1,2,4-trimethyl-benzene; 2-methyl-1,3-butadiene; 3-methyl-octane; 1-hexene; 3-methyl-nonane; 1-heptene; 1,4-dimethyl-benzene; 2,4-dimethyl-heptane; hexanal; 1-methylethenyl-benzene; hepatanal; isobutane; methanol; ethanol; acetone; pentane; isopropanol; dimethylsulfide; carbon disulfide; toluene; hexane; methyl pentane; o-toluidine; and aniline.

18. The apparatus of claim 1, wherein the one or more particles are gold nanoparticles, the one or more enzymes are cytochrome P450-dependent styrene monooxygenase, and the at least one VOC is styrene.

19. The apparatus of claim 1, wherein the one or more particles are gold nanoparticles, the one or more enzymes are alkane hydroxylase, and the at least one VOC is decane.

20. A method for detecting a volatile organic compound (VOC) in an assayed sample, the method comprising:
(a) introducing the sample to be assayed into the reaction cell of the biosensor comprising: (i) a reaction cell with a primary electrode; one or more particles coupled to the primary electrode, wherein the one or more particles are coupled to one or more enzymes that are capable of undergoing a redox reaction with at least one VOC; and a reference electrode, and (ii) a detector configured to measure current or voltage generated between the primary electrode and the reference electrode in response to the redox reaction, and
(b) measuring the current or voltage generated between the primary electrode and the reference electrode.
